(19) United States
(12) Patent Application Publication
(10) Pub. No.: US 2014/0145403 A1
(43) Pub. Date: May 29, 2014

(54) Seal Arrangement for Sealing a Reciprocating Piston Rod of a Piston Compressor

(71) Applicants: Martin LAGLER, Wien (AT); Christian Hold, Bisamberg (AT); Alexander Jandl, Hoflein (AT); Tino Lindner-Silwester, Wien (AT); Alexander Loedl, Wien (AT)

(72) Inventors: Martin LAGLER, Wien (AT); Christian Hold, Bisamberg (AT); Alexander Jandl, Hoflein (AT); Tino Lindner-Silwester, Wien (AT); Alexander Loedl, Wien (AT)

(73) Assignee: Hoerbiger Kompressortechnik Holding GmbH, Wien (AT)

(21) Appl. No.: 14/088,578

(22) Filed: Nov. 25, 2013

(30) Foreign Application Priority Data
Nov. 28, 2012 (AT) A 50548/2012

(51) Int. Cl. F16J 15/00

(52) U.S. Cl. CPC F16J 15/002
USPC 277/350

(57) ABSTRACT

To reduce leakage of pressure medium in a seal arrangement (1) comprising two sealing elements (8) that are pressed by a sealing medium against the piston rod (3) and against a wall (11) of a recess (10), it is provided that the radially interiorly disposed circumferential surface (24) constitutes at least one of the sealing elements (8) from a sealing surface (12) and a tributary area (23), a second end face (21) that faces away from the axial end (11) of the recess (10) connecting to the sealing surface (12), and a rigid cover ring (9) being provided that is positioned at least in part radially against the radially exterior circumferential surface (25) of the sealing element (8) and at least in part axially against the second end face (21) of the sealing element (8).

The subject-matter invention relates to a seal arrangement for sealing a reciprocating piston rod of a piston compressor having a first and second sealing element, which sealing elements are arranged spaced apart axially in a recess of the seal arrangement, the seal elements being arranged with a first end face positioned against an axial end of the recess and with a sealing surface positioned against the piston rod and a supply line for a sealing medium that communicates with the recess being provided in the seal arrangement.

In a piston compressor, the space with high pressure, e.g. the working pressure in the cylinder of the compressor, is to be sealed along the piston rod against a space with low pressure, e.g. the atmospheric pressure in the crankcase of the compressor. To this end, so-called “packing” is used that provides a seal between the reciprocating piston of the piston compressor and a fixed machine part, as a rule the crankcase. As a rule, such packing includes a plurality of packing rings or packing ring combinations that are arranged axially adjacent to one another. Most frequently, combinations of a radially cut and a tangentially cut packing ring are used, as proceeds e.g. from EP 1 146 264 A2. In addition, segmented ring designs are also used in which a packing ring is combined from a plurality of ring segments, such as is known e.g. from U.S. Pat. No. 4,350,349 A. However, such seals are not 100% sealed systems; on the contrary, a certain amount of the working medium from the compressor always escapes through the seal.

To reduce the problem of leakage, WO 2010/079227 A1 has already suggested using two axially spaced sealing elements between which a sealing medium, e.g. oil, is added at high pressure so that the sealing elements are pressed against sealing surfaces, which are provided for sealing and which are in the packing, and are pressed against the piston rod. In this manner a sealing medium barrier is created that at least the amount of working medium, such as e.g. air or natural gas, that leaks from the compressor along the piston rod, and ideally even eliminates this leakage, as is desired. However, there may be a leak of sealing medium between sealing element and piston rod, primarily due to the sealing medium film that adheres to the surface of the reciprocating piston rod and thus is transported and stripped out of the seal. Since the sealing element is produced from a tribologically favorable material, as a rule a plastic, due to the acting pressure differences and the geometry of the sealing element the sealing element may be deformed during operation, which negatively impacts the sealing surface and the sealing edge of the sealing element and thus increases leakage of sealing medium. This sealing medium leakage should be kept as low as possible in the desired manner, however.

It is therefore an object of the subject-matter invention to provide a seal arrangement of the type specified in the foregoing with which leakage of sealing medium through the seal may be effectively reduced.

This is attained with a sealing element of a seal in which the radially interiorly disposed circumferential surface constitutes at least one of the sealing elements from the sealing surface and an adjacent tributary area, the tributary area being arranged at an angle to the sealing surface and a second end face of the sealing element that faces away from the axial end of the recess connecting to the sealing surface, and further a rigid cover ring being provided that is positioned at least in part radially against the radially exterior circumferential surface of the sealing element and at least in part axially against the second end face of the sealing element. Because the cover ring is arranged positioned axially and radially against the second end face of the sealing element that is connected to the sealing surface of the sealing element, the cover ring actively intervenes in the deformation of the sealing edge or the sealing gap that forms between sealing element and piston rod and supports the sealing edge. Due to the reciprocating movement of the piston rod, the sealing medium is drawn into the sealing gap, which causes pressure to build up in the sealing gap, urging the sealing element to expand radially. Because of the cover ring, the sealing gap cannot open too wide due to the reciprocating movement of the piston rod and the sealing medium film adhering thereto, which would lead to increased leakage of sealing medium through the seal. In addition, the cover ring also supports the sealing ring against reverse torque that occurs and urges the sealing element to deform, which would also have a negative effect on the sealing edge and the sealing gap and would also increase leakage of sealing medium through the seal.

An L-shaped cover ring is simple and may advantageously be embodied in a compact manner.

For desired low frictional forces and frictional power and low amounts of sealing medium leakages, it has proved particularly advantageous when the cover ring is positioned axially against the sealing element against a portion of the radial height of the sealing element, preferably against at least 35% to a maximum of 85% of the radial height, or the sealing surface extends across a maximum of 50% of the axial width of the sealing element, or the tributary area is at an angle of a maximum of 4° with respect to the sealing surface, or the second end face of the sealing surface is at an angle of at least 75° with respect to the sealing surface, or the cover ring is positioned against at least 25% to a maximum of 100% of the axial width of the radially exterior circumferential surface of the sealing element. Very particularly preferred is a sealing element-cover ring combination that satisfies all or at least a plurality of the aforesaid features.

To avoid deformations in the sealing element caused by extrusions of the sealing element into the gap between chamber disk and piston rod, a support ring against which the sealing element is axially positioned is advantageously arranged between the axial end of the recess and the sealing element.

Very particularly preferred, the support ring is positioned radially exteriorly against an axial shoulder that faces the sealing element. In this manner it is possible to prevent the support ring from touching the piston rod.

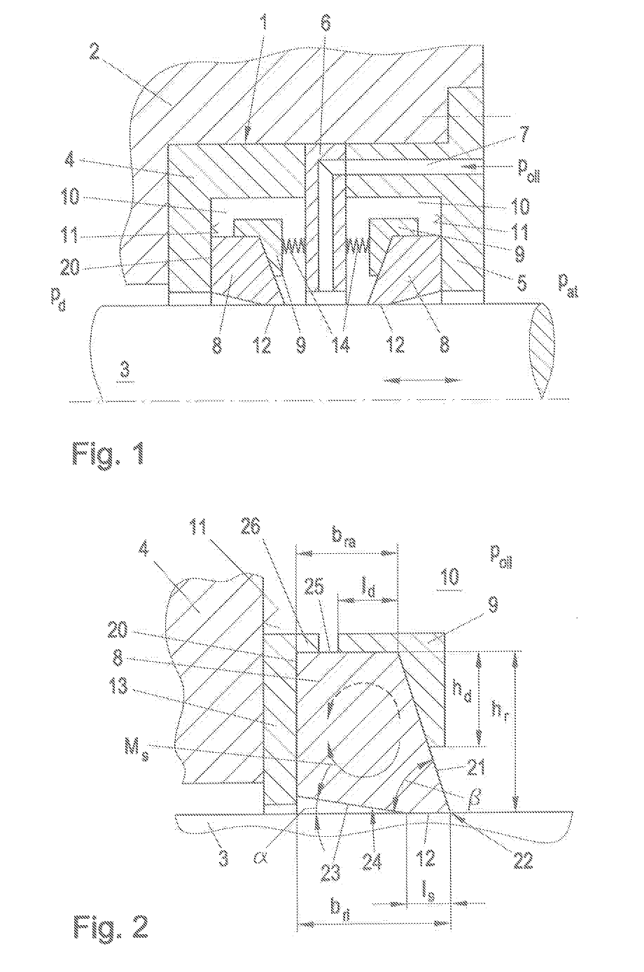

The subject-matter invention shall be explained in greater detail in the following, referencing FIGS. 1 and 2, which schematically illustrate non-limiting and advantageous embodiments of the invention

FIG. 1 is an inventive seal arrangement, and

FIG. 2 is a detail of a sealing element for an inventive seal arrangement.

FIG. 1 depicts an inventive seal arrangement 1 for sealing an axially reciprocating piston rod 3 of a piston compressor against a pressure difference p_{d}−pₐₜ that is to be sealed for a working medium, e.g. the difference between cylinder pressure p_{d} and pressure in the crankcase pₐₜ. The seal arrangement 1 is arranged in a fixed housing pad 2 of the compressor and seals this housing part 2 from the moved piston rod 3.

In the example shown, the seal arrangement 1 includes two L-shaped chamber disks 4, 5 that in the illustrated exemplary embodiment are separated axially by a partitioning disk 6. The L-shaped chamber disks 4, 5 and the partitioning disk 6 are arranged positioned axially against one another and spaced apart radially from the piston rod 3 to prevent the piston rod 3 from rubbing against the chamber disks 4, 5 and the separating disk 6 and to permit the piston rod 3 to move transverse to the stroke (indicated by the double arrow). However, in the most simple case, the partitioning disk 6 may also be omitted. Other embodiments are also possible, however, e.g. with T-shaped partitioning disks. A flange may also be provided radially exteriorly against a chamber disk 5, by means of which flange the seal arrangement 1 may be attached to the housing part 2. The chamber disks 4, 5 and where necessary the partitioning disk 6 may be held together in a known manner by a bolt that passes through them. This arrangement results in two recesses 10 between the L-shaped chamber disks 4, 5, possibly the partitioning disk 6, and the piston rod 3, one sealing element 8 being arranged in each. However, in principle it would also be possible for only one sealing element 8 to be provided in one of the recesses 10 or the sealing elements 8 could also be embodied differently. The sealing element 8 is embodied as an integral sealing ring that is not cut in the circumferential direction and is pressed against the axial ends 11 of the recess 10, that is against the radial legs of the L-shaped chamber disks 4, 5, by the acting pressure of a sealing medium that is under pressure and is supplied to the recess 10 (the “axial” and “radial”orientations relate to the orientation of the piston rod 3). The sealing elements 8 are arranged radially exteriorly spaced apart from the chamber disks 4, 5, that is, from the axial legs of the chamber disks 4, 5, and their sealing surfaces 12 that extend axially are positioned radially inwardly against the piston rod 3. A rigid, non-partitioned, e.g. metal cover ring 9 is positioned radially and axially against the sealing elements 8, as explained in detail in the following, referencing FIG. 2.

A spring element 14, e.g. a plurality of coil springs distributed around the circumference, may also be arranged between the cover ring 9 and an axial stop in the seal 1, in this case e.g. the partitioning disk 6, pre-stressing the cover ring 9 and thus the sealing element 8 axially towards the axial end 11 of the recess 10. The two sealing elements 8 are consequently pressed away from one another by the spring element 14. This means that in particular when at a stop a defined position for the sealing element 8 is assured so that the seal 1 or the compressor can be safely started.

Further provided in the seal arrangement 1 is a supply line 7 that communicates with the recess 10 and via which a sealing medium, such as e.g. an oil at a pressure pₒᵢₗ that is greater than the pressure to be sealed p_{d}, or, in certain embodiments that is at least greater than the suction pressure of the compressor, may be supplied to the recess 10. In the case of a dynamically changing working pressure p_{d}, naturally pₒᵢₗ must be greater than p_{d,max}, or the pressure of the sealing medium must be dynamically adapted to the pressure of the working medium so that pₒᵢₗ is always greater than p_{d}. The sealing medium acts radially exteriorly and axially on the sealing element 8 and the sealing ring 9, which are therefore pressed radially inward against the piston rod 3 and axially against the chamber disks 4, 5, and thus create the seal. This creates a sealing medium barrier that prevents the gaseous working medium that is in the compressor and that is to be sealed off from leaking along the piston rod 3.

FIG. 2 is an enlarged depiction of an advantageous embodiment of a sealing element 8. Additionally arranged in FIG. 2 between sealing element 8 and the axial end 11 of the recess 10 is an optional support ring 13 against which a first end face 20 of the sealing element 8 is positioned. The support ring 13 is positioned axially against the chamber disk 4. As described in the foregoing with respect to FIG. 1, the support ring 13 may also be omitted so that the first end face 20 of the sealing element 8 would be positioned axially directly against the axial end 11 of the recess 10, that is, in this case, against the chamber disk 4.

The sealing element 8 has a radially inner circumferential surface 24 that constitutes a sealing surface 12 and an adjacent tributary area 23. The sealing surface 12 is provided at the axial end of the sealing element 8 that faces away from the first end face 20. The tributary area 23 is at an angle α relative to the sealing surface 12 and preferably connects the sealing surface 12 to the first end face 20. The second axial end face 21 of the sealing element 8 opposing the first end face 20 is arranged at an angle β with respect to the sealing surface 12 and preferably connects to the sealing surface 12. The edge between sealing surface 12 and the second end face 21 embodies the sealing edge 22.

The sealing element 8 is thus positioned against the piston rod 3, against which it is pressed at high pressure (pₒᵢₗ), only at the small sealing surface 12. This causes high frictional loads that the sealing element 8 must withstand for an adequate period of time. The sealing element 8 is therefore preferably made from a tribologically favorable material, but a material that is also temperature-stable and very strong mechanically, preferably plastic, such as e.g. modified PEEK or PPS materials. Forces that press the sealing element 8 against the chamber disk 4 and the support ring 13, and against the piston rod 3 with the sealing surface 12, act on the sealing element 8 and the cover ring 9 through the pressure of the sealing medium. At a sealing medium pressure pₒᵢₗ of approx. 50 bar, between sealing element 8 and piston rod 3 frictional forces occur that are a few hundred Newtons, typically between 100 N and 250 N, and friction power occurs that is a few hundred Watts, typically between 500 W and 100 W. Due to these forces and the geometry of the sealing element 8, however, reverse torques Mₛ also act on the sealing element 8 and urge the sealing element 8 to deform. In particular the very small sealing surface 12 and the sealing edge 22 are very sensitive to this and such reverse torques Mₛ may interfere with the contact between piston rod 3 and the sealing surface 12, which would cause leakage of sealing medium to increase. The cover ring 9 is provided to reduce or prevent this and is positioned axially against the forward second end face 21 (which is connected to sealing surface 12) of the sealing element 8, and therefore supports the sealing edge 22 against deformation so that the latter cannot deform or can only deform to a minor degree. In addition, part of the sealing ring 9 is positioned against the sealing element 3 across the height h_{d}, the height h_{d} advantageously being at least 35% to 85% of the height hᵣ of the sealing element 8.

It has also been found that the sealing element 8 may expand radially during operation, especially during multiple start/stop operation by the compressor, during start/stop of the sealing medium supply system, or during start-up if the sealing element has to run in first, which would also naturally increase leakage of the sealing medium. To suppress this, the cover ring 9 covers the sealing element 8 axially and also on the radially exterior circumferential surface 25. To this end, the cover ring 9 is positioned along a length l_{d} against the exterior circumferential surface 25, the length l_{d} advantageously being at least 25% to 100% of the width bᵣₐ of the sealing element 8 on the exterior circumferential surface 25. Thus the cover ring 9 has an L-shaped cross-section.

For favorable operation of the sealing element 8, that is, for low frictional forces or power and a low amount of sealing medium leakage, it has furthermore proved advantageous when the angle α is less than 4° but greater than zero, and the angle β is greater than 75°, wherein it is also possible to have angles greater than 90°. It is likewise advantageous for this when the length lₛ of the sealing surface 12 is a maximum of 50% of the width bᵣᵢ of the sealing element 8 on the inner circumferential surface 24.

Radially exteriorly the support ring 13 may have an axial shoulder 26 that faces the sealing element 8 and via which the support ring 13 is radially positioned against the sealing element 8 to prevent the support ring 13, which is typically made of metal, from coming into contact with the piston rod 3. In this case the cover ring 9 is preferably positioned against the exterior circumferential surface 25 along a length l_{d} of at least 25% to 75% of the width bᵣₐ of the sealing element 8 to create room for the shoulder 26. The support ring 13 prevents, in a known manner, the sealing element 8 from being extruded into the gap between chamber disk 4 and piston rod 3 due to the acting pressure difference, which could have a negative impact on the functioning of the sealing element 8.

1. A seal arrangement for sealing a reciprocating piston rod (3) of a piston compressor having a first and second sealing element (8), which sealing elements are arranged spaced apart axially in a recess (10) of the seal arrangement (1), the seal elements (8) being arranged with a first end face (20) positioned against an axial end (11) of the recess (10) and with a sealing surface (12) positioned against the piston rod (3) and a supply line (7) for a sealing medium that communicates with the recess (10) being provided in the seal arrangement (1), wherein the radially interiorly disposed circumferential surface (24) constitutes at least one of the sealing elements (8) from the sealing surface (12) and an adjacent tributary area (23), the tributary area (23) being arranged at an angle to the sealing surface (12), in that a second end face (21) that faces away from the axial end (11) of the recess (10) connects to the sealing surface (12), and in that a rigid cover ring (9) is provided that is positioned at least in part radially against the radially exterior circumferential surface (25) of the sealing element (8) and at least in part axially against the second end face (21) of the sealing element (8).

2. The seal arrangement in accordance with claim 1, wherein the cover ring (9) is embodied in an L shape.

3. The seal arrangement in accordance with claim 1, wherein the cover ring (9) is positioned axially against the sealing element (8) against a portion (h_{d}) of the radial height (hᵣ) of the sealing element (8), preferably against at least 35% to a maximum of 85% of the radial height (hᵣ).

4. The seal arrangement in accordance with claim 1, wherein the sealing surface (12) extends across a length (lₛ) of a maximum of 50% of the axial width (bᵣᵢ) of the radially interior circumferential surface (24) of the sealing element (8).

5. The seal arrangement in accordance with claim 1, wherein the tributary area (23) is at an angle of a maximum of 4° with respect to the sealing surface (12).

6. The seal arrangement in accordance with claim 1, wherein the second end face (21) of the sealing element (8) is at an angle of at least 75° with respect to the sealing surface (12).

7. The seal arrangement in accordance with claim 1, wherein the cover ring (9) is positioned against at least 25% to a maximum of 100% of the axial width (bᵣₐ) of the radially exterior circumferential surface (25) of the sealing element (8).

8. The seal arrangement in accordance with claim 1, wherein a support ring (13) against which the sealing element (8) is axially positioned is arranged between the axial end (11) of the recess (10) and the sealing element (8).

9. The seal arrangement in accordance with claim 8, wherein the support ring (13) radially exteriorly has an axial shoulder (26) that faces the sealing element (8) and that is positioned is arranged positioned radially exteriorly against the sealing element (8).
